(19) United States
(12) Patent Application Publication
(10) Pub. No.: US 2007/0213993 A1
(43) Pub. Date: Sep. 13, 2007

(54) Tool and process for acquisition of a large number of employees from another company in a plurality of countries

(75) Inventors: Kristen Kelly Brink, Sterling, IL (US); Andrew Dondlinger, St. Charles, IL (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 11/371,135

(22) Filed: Mar. 7, 2006

(51) Int. Cl. G06Q 10/00; G06Q 30/00

(52) U.S. Cl. 705/1

(57) ABSTRACT

Employees are acquired in many countries as a result of an outsourcing deal. Compliance with the different laws and regulations as well as cultural and language differences is determined and maintained simultaneously for all countries involved, rather than one at a time as in prior art tools and processes. Interconnected workstream and layer tools operate to insure overall success.

### TECHNICAL FIELD

The invention relates to systems, methods and tools for acquisition in a short period of time of a large number of employees from another company in a plurality of countries as, for example, may occur in an outsourcing deal. More particularly the invention relates to such acquisitions in which the acquired employees are initially substantially engaged in providing business services back to their former employer.

### BACKGROUND OF THE INVENTION

Outsourcing deals are common today between a company engaged in providing products or services and a business services providing company. The first company becomes more competitive by focusing on and concentrating its resources on its core competencies by allowing the second company to pick up and handle those parts of the business which are necessary but not critical to its overall competitiveness, such as payroll processing, various accounting and finance functions, providing human resources functions, facilities maintenance and the like.

The second company, by concentrating on providing such services to various companies is able to develop specific expertise in these areas, employ economies of scale, make more effective use of labor in low wage scale countries, and overall provide these less essential services to the first company more economically than the first company can do for itself.

One way of developing expertise is to make use of information technology tools developed specifically for providing such services. For example, in the human resources area, an employee reward system is described by Fredregill et al. in PCT (Patent Cooperation Treaty) patent application WO 01/86545. This application shall be incorporated herein by reference. The second company may be able to make more effective use of such tools through the economies of scale of use with additional clients, even though additional licenses may be required.

When an outsourcing deal is initially developed and proposed for some or all of these services, it is a common practice for the second company to agree to “pick up” those employees of the first company who are currently engaged in providing these functions or services. The employees become employees of the second company and at least initially continue to perform the same jobs. Over time, however, due to the expertise and economies of scale mentioned above, some of these employees will be able to be shifted to other jobs within the second company, including providing similar services to other client companies. Likewise, as some of these employees move on, they may be replaced by other employees of the second company or by new hires.

Due to great developments in telecommunication, these other employees and new hires may be located in different countries than the employees being replaced. In this case, as well as when the first and second companies have employees located in a plurality of countries, a great number of complicating laws, regulations, and cultural differences arise which must be managed effectively or the entire outsourcing deal risks failure. Indeed, a number of such failures are known to have occurred.

Currently, there is no overall system or method for managing such acquisitions of employees so that a successful outsourcing deal is possible. Consequently, ad hoc methods are generated specifically for each deal, resulting in great inefficiencies, lost opportunities, and failures.

There is, therefore, a need in the art for an employee acquisition process that will enable consistency of employee acquisition across a plurality of countries which assures compliance with the laws, regulations, and customs of each country and produces successful results. It is believed that such a process would constitute a significant advancement in the services providing arts.

### OBJECTS AND SUMMARY OF THE INVENTION

It is an object of the present invention to enhance the employee acquisition art by providing a system with consistent and successful capabilities.

It is another object to provide such a system wherein enhanced performance capabilities are possible.

It is a further object to provide such a system which can be deployed in a facile manner.

It is yet another object of the invention to provide a method of managing employee acquisitions having enhanced operational capabilities.

These and other objects are attained in accordance with one embodiment of the present invention wherein there is provided a system for acquiring employees in a plurality of countries, comprising; a people workstream, an operations workstream, a workplace workstream, a program management layer, a governance layer, a legal and tax layer, and wherein the layers provide global oversight but do not execute tools for performing tasks defined by templates and checklists in the workstreams.

In accordance with another embodiment of the invention there is provided a method of managing the simultaneous acquisition of employees in a plurality of countries, comprising the steps of; performing first tasks using a people workstream tool, performing second tasks using an operations workstream tool, performing third tasks using a workplace workstream tool, overseeing said tasks in a program management layer, overseeing the tasks in a governance layer, overseeing the tasks in a legal and tax layer, and wherein the tasks are defined by templates and checklists, and the overseeing is provided as global oversight.

In accordance with yet another embodiment of the invention, there is provided a method of deploying a system for acquiring employees in a plurality of countries, comprising; providing a computer infrastructure being operable to perform first tasks using a people workstream tool, perform second tasks using an operations workstream tool, perform third tasks using a workplace workstream tool, oversee the tasks in a program management layer, oversee said tasks in a governance layer, oversee the tasks in a legal and tax layer, and wherein the tasks are defined by templates and checklists, and the overseeing is provided as global oversight.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a system diagram of interconnected tools for acquisition of employees in accordance with the present invention; and

FIG. 2 is a flowchart depicting the steps of a method of executing the present invention.

### BEST MODE FOR CARRYING OUT THE INVENTION

In accordance with the preferred embodiment of the invention, a system and method is provided by which to acquire employees in a manner enabling consistency, compliance, and re-usability across different outsourcing deals with comparable results. Current methods tend to result in different solutions for different deals with inconsistent and sometimes unsatisfactory results.

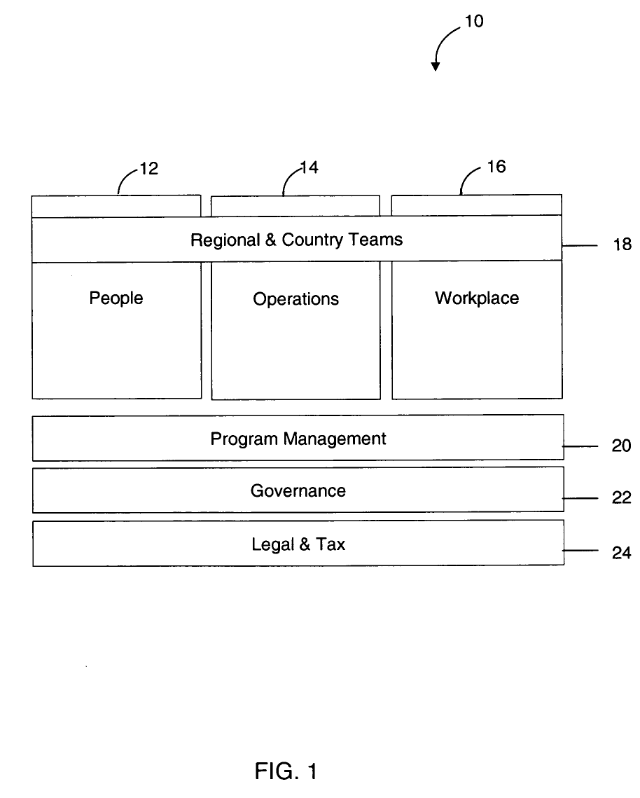

Referring to FIG. 1, there is shown system diagram 10 of interconnected tools in accordance with the present invention. There are basically two kinds of tools in system 10. Workstream tools 12, 14, 16 define and provide a capability of performing tasks which need to be accomplished in practicing the present invention. More details, including specific tasks and examples for each of the workstreams, people 12, operations 14, and workplace 16, are given below. For each workstream, a leader is selected and a team formed to operate the tool and perform the tasks required for that workstream.

The workstream tools capture the requirements of the various countries involved. Previous art tools are country specific and didn't capture in particular the legal and compliance issues which arise in various countries. The workstream tools of the present invention comprise templates, spreadsheets, and checklists which capture work rules and the like. Human resources experts from each country develop these templates, spreadsheets, and checklists which are part of the tool and re-used on additional deals. As a result, use of the present invention tools establishes compliance for a plurality of countries simultaneously, rather than individually one at a time as with previous tools.

People workstream 12 is concerned with transferring a large number of employees in many countries to a new company, all on the same day. Issues such as people re-badging are addressed. People workstream tool 12 also provides a capability for making employment offers to staff in a plurality of countries at the time required in those countries. People workstream tool 12 includes a capability of processing accepted employment offers within the receiving organization in those local countries. People workstream tool 12 also includes a capability for determining employee benefits required in each local country to equalize employees based on an agreement made with their previous employer and for executing employees benefit plans, including healthcare and pensions in accordance with this determination.

Operations workstream 14 is concerned with insuring supporting technologies and workstation capabilities are available to the transferred people.

Workplace workstream 16 deals with work facilities, whether transferred or leased are sufficiently available and maintained. Physical security requirements such as locked doors and access are addressed.

Bridging across the workstreams are layers 20, 22, and 24. A layer is an oversight tool for insuring the tasks to be performed by the workstreams are in fact completed as needed and that legal, cultural, and language differences are addressed. Global and regional issues are addressed. As used herein, the term “global”, shall be taken to mean countries located anywhere, whether in the United States, Canada, Europe, Middle East, Asia, South America, or Africa. The term “regional” shall be taken to mean countries located near each other geographically and having some common regulations such as western Europe or South America. “Oversee” shall be taken to mean that there is a management structure established that manages the workstreams and ensures the completion of the tasks associated with each workstream. “Oversee” also means ensuring there are individuals in each country or region who are executing the actual work to accomplish the tasks defined by the workstream tools.

Program management layer 20 globally oversees the operation of services provided to the first company, but does not execute the workstream tools. Program management layer 20 also oversees any reporting back to the first company of the overall progress of implementing the workstream processes.

Governance layer 22 insures that agreements are signed in each country. Governance layer 22 also develops processes which are jointly managed and executed by all of the workstreams, including a financial management process and a software license process.

Legal and tax layer 24 oversees intellectual property handling, contracts and other legal requirements. For example, a single master United States contract won't work in many countries. Layer 24 insures companion contracts are provided for every legal entity.

In addition, regional and country teams layer 18 oversees operation of workstream tools 12, 14, 16 in a particular region or country as needed.

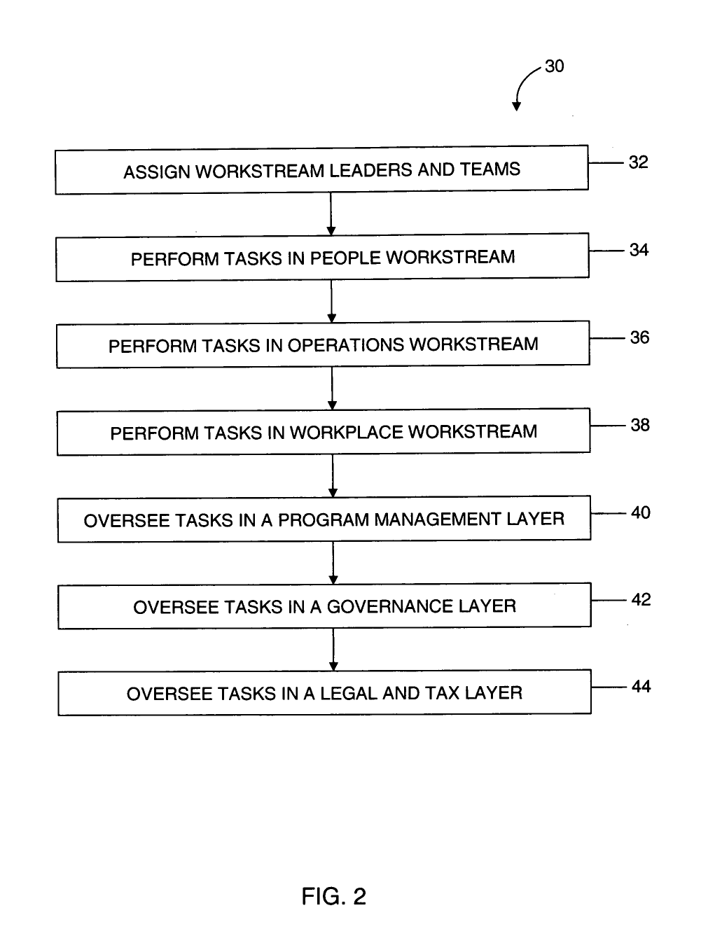

In FIG. 2, there is shown flowchart 30 depicting the steps of a method for acquiring employees in accordance with another embodiment of the present invention. In step 32, workstream leaders and teams are assigned to carry out the defined tasks of the employee acquisition.

The tasks are defined by templates, spreadsheets, and checklists in the people, operations, and workplace workstream tools as noted above. In steps 34, 36, and 38, the assigned teams and leaders of the people, operations, and workplace respective workstreams carry out or perform the defined tasks. Note that although steps 34, 36, and 38 are shown sequentially in flowchart 30, these steps may in fact overlap or be performed simultaneously without departing from the scope of the presently claimed invention.

In steps 40, 42, and 44, the program management, governance, and legal and tax layer tools respectively are used to oversee, but not execute, the tasks defined for the workstreams.

While there have been shown and described what are at present considered to be the preferred embodiment of the invention, it will be obvious to those skilled in the art that various changes and modifications may be made therein without departing from the scope of the invention as defined by the appended claims.

What is claimed is:

1. A system for acquiring employees in a plurality of countries, comprising:
a people workstream;
an operations workstream;
a workplace workstream;
a program management layer;
a governance layer;
a legal and tax layer; and
wherein said layers provide global oversight but do not execute tools for performing tasks defined by templates and checklists in said workstreams.

2. The system of claim 1, further comprising a global team layer for communicating back to an organization from which said employees are acquired.

3. The system of claim 1, wherein said templates are spreadsheet templates.

4. The system of claim 1, wherein said governance layer oversees power of attorney agreements executed by said operations workstream.

5. The system of claim 1, wherein each of said workstreams comprise an assigned leader and team.

6. The system of claim 1, wherein said legal and tax layer oversees compliance requirements of each of said plurality of countries by each of said workstreams.

7. The system of claim 6, wherein said compliance requirements are captured and packaged in a matrix.

8. A method of managing the simultaneous acquisition of
employees in a plurality of countries, comprising the steps of:
performing first tasks using a people workstream tool;
performing second tasks using an operations workstream tool;
performing third tasks using a workplace workstream tool;
overseeing said tasks in a program management layer;
overseeing said tasks in a governance layer;
overseeing said tasks in a legal and tax layer; and
wherein said tasks are defined by templates and checklists, and said overseeing is provided as global oversight.

9. The method of claim 8, further comprising the step of communicating back to an organization from which said employees are acquired, using a global team layer.

10. The method of claim 8, wherein said templates are spreadsheet templates.

11. The method of claim 8, wherein said governance layer oversees power of attorney agreements executed by said operations workstream.

12. The method of claim 8, wherein each of said workstreams comprise an assigned leader and team.

13. The method of claim 8, wherein said tasks in said legal and tax layer comprise compliance requirements of each of said plurality of countries by each of said workstreams.

14. The method of claim 13, wherein said compliance requirements are captured and packaged in a matrix.

15. A method of deploying a system for acquiring employees in a plurality of countries, comprising:
providing a computer infrastructure being operable to:
perform first tasks using a people workstream tool;
perform second tasks using an operations workstream tool;
perform third tasks using a workplace workstream tool;
oversee said tasks in a program management layer;
oversee said tasks in a governance layer;
oversee said tasks in a legal and tax layer; and
wherein said tasks are defined by templates and checklists, and said overseeing is provided as global oversight.
